(19) United States
(12) Patent Application Publication
(10) Pub. No.: US 2019/0072177 A1
(43) Pub. Date: Mar. 7, 2019

(54) SHIFT-BY-WIRE VEHICLE SHIFTING DEVICE FOR CHANGING SHIFT-RANGE OF VEHICLE AMONG A PLURALITY OF SHIFT-RANGES BASED ON MANIPULATION MADE BY DRIVER

(71) Applicant: MAZDA MOTOR CORPORATION, Hiroshima (JP)

(72) Inventors: Masayuki TOKUMO, Hiroshima-shi (JP); Tomonori OHTSUBO, Hiroshima-shi (JP); Hiroki UEMURA, Hiroshima-shi (JP); Yoshito HIRATA, Hiroshima-shi (JP); Kouji TOKUNAGA, Hiroshima-shi (JP)

(73) Assignee: MAZDA MOTOR CORPORATION, Hiroshima (JP)

(21) Appl. No.: 16/118,311

(22) Filed: Aug. 30, 2018

(30) Foreign Application Priority Data
Sep. 6, 2017 (JP) 2017-171166

(51) Int. Cl. F16H 59/10; F16H 59/12

(52) U.S. Cl. CPC F16H 59/105; F16H 59/12

(57) ABSTRACT

A vehicle shifting device is a shift-by-wire vehicle shifting device for changing a shift-range of a vehicle among a plurality of shift-ranges including a parking range, a reverse range, a neutral range, and a drive range based on manipulation made by a driver. The vehicle shifting device includes a shift lever that is set to positions corresponding to the plurality of shift-ranges, a detector that detects the position of the shift lever, and a lever holder that keeps the shift lever in one of the positions while the shift-range is kept in a predetermined shift-range, the one of the positions corresponding to the predetermined shift-range.

### TECHNICAL FIELD

The present invention relates to a vehicle shifting device, more particularly, a shift-by-wire vehicle shifting device.

### BACKGROUND ART

In recent years, a vehicle shifting device so called a shift-by-wire vehicle shifting device is known that electrically detects a position of a shift lever and transmits an electric signal to a controller to perform shifting. Such a shift-by-wire shifting device is advantageously free of limitation on manipulation stroke of a shift lever and small in size.

Furthermore, the shift-by-wire shifting device gives a high degree of freedom in designing a vehicle.

Japanese Patent Application Laid-Open No. 2007-253912 discloses an example of a shift-by-wire shifting device. Japanese Patent Application Laid-Open No. 2007-253912 discloses a shift-by-wire shifting device in which reverse (R) range and drive (D) range are selected by manipulating a shift lever and parking (P) range and neutral (N) range are selected or cancelled by using a push button switch.

The shift-by-wire shifting device disclosed in Japanese Patent Application Laid-Open No. 2007-253912 is such that a home position is provided among the reverse (R) position and the drive (D) position of the shift lever and the shift lever returns to the home position by a driver releasing a shift knob from a hand when shift manipulation is completed.

Such a shift-by-wire shifting device according to the prior art is a momentary shifting device.

As in the art disclosed in Japanese Patent Application Laid-Open No. 2007-253912, the momentary shifting device has a disadvantage in that a driver finds it difficult to recognize a current driving range. Before the shift-by-wire shifting device has come to be used, the shifting device performed shifting mechanically via a cable and thus the current driving range can easily be recognized by the position of the shift lever. For the momentary shifting device, it is difficult to recognize the driving range by the position of the shift lever, and thus a driver should always check an indicator in a metering unit.

### SUMMARY OF INVENTION

An object of the present invention is to provide a vehicle shifting device that uses shift-by-wire mechanism to reduce the overall size of the device and gives a high degree of freedom in designing while allowing a driver to recognize a shift position by the position of a shift lever.

A shift-by-wire vehicle shifting device according to one aspect of the present invention is for changing a shift-range of a vehicle among a plurality of shift-ranges including a parking range, a reverse range, a neutral range, and a drive range based on manipulation made by a driver. The vehicle shifting device includes a shift lever that is set to positions corresponding to the plurality of shift-ranges, a detector that detects the position of the shift lever, and a lever holder that keeps the shift lever in one of the positions while the shift-range is kept in a predetermined shift-range, the one of the positions corresponding to the predetermined shift-range.

### BRIEF DESCRIPTION OF DRAWINGS

FIG. 1 is a schematic view illustrating a vehicle interior space in which a vehicle shifting device according to an embodiment is applied;

FIG. 2 is a schematic perspective view illustrating an external configuration of the vehicle shifting device;

FIG. 3 is a schematic plan view illustrating a movement of a shift lever of the vehicle shifting device;

FIG. 4 is a schematic perspective view illustrating a configuration of the shift lever;

FIG. 5 is a schematic sectional view taken along the line V-V in FIG. 4;

FIG. 6 is a schematic sectional view illustrating a movement of a detent mechanism when the shift lever is manipulated among P-position and R-position;

FIG. 7 is a schematic sectional view illustrating a movement of the detent mechanism when the shift lever is manipulated among the R-position and D-position;

FIG. 8 is a schematic sectional view illustrating a movement of a guide lever when the shift lever is manipulated among the P-position and the R-position; and

FIG. 9 is a schematic sectional view illustrating a movement of a guide lever when the shift lever is manipulated among the R-position and the D-position;

### DESCRIPTION OF EMBODIMENTS

An embodiment of the present invention will be described with reference to the drawings. It should be noted that the embodiment described below is an example of the present invention. The embodiment is disclosed by means of illustration and not by means of limitation except for the essential configuration.

In the drawings referred in the description below, “+X” indicates the right side of the vehicle, “−X” indicates the left side of the vehicle, “+Y” indicates the front side of the vehicle, “−Y” indicates the rear side of the vehicle, “+Z” indicates the upper side of the vehicle, and “−Z” indicates the lower side of the vehicle.

### EMBODIMENT

1. Vehicle Shifting Device 1 and Peripheral Configuration Thereof

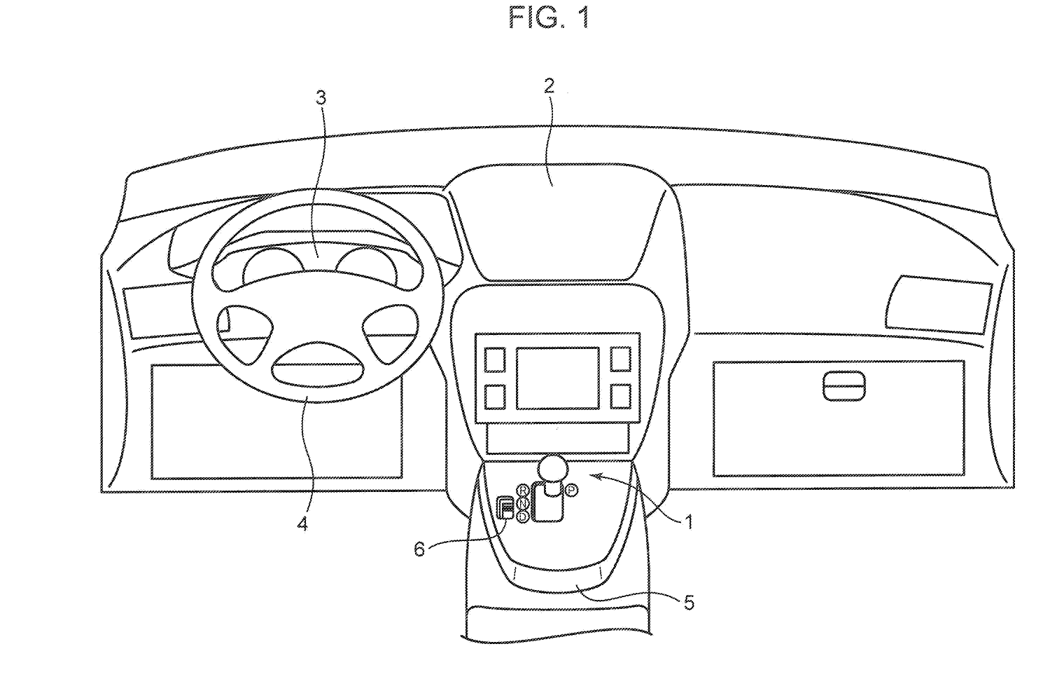

The vehicle shifting device 1 and its peripheral configuration in the vehicle interior space will be described with reference to FIG. 1.

As illustrated in FIG. 1, a metering unit 3 in the instrumental panel 2 and a steering wheel 4 are disposed in front of a driver's seat. The metering unit 3 displays the speed, the engine speed, the gear range, etc.

A central console 5 is provided between a driver's seat and a front passenger's seat. The central console 5 is provided to extend in the front-and-rear direction of the vehicle and has a substantially flat top face on which a driver can rest an arm.

The central console 5 is provided with the vehicle shifting device 1 and a parking switch 6. The vehicle shifting device 1 according to the embodiment is a shift-by-wire shifting device. In response to an input from a driver, the vehicle shifting device 1 outputs a command signal for changing the shift-range to an automatic transmission (not shown) via a controller (e.g., ECU).

The vehicle shifting device 1 can change the shift-range among parking range (P-range), reverse range (R-range), neutral range (N-range), and drive range (D-range).

The parking switch 6 is a switch connected to a solenoid for manipulating a parking brake. The parking brake works by a driver pulling up the front portion of the parking switch 6.

2. The External Configuration of the Vehicle Shifting Device 1

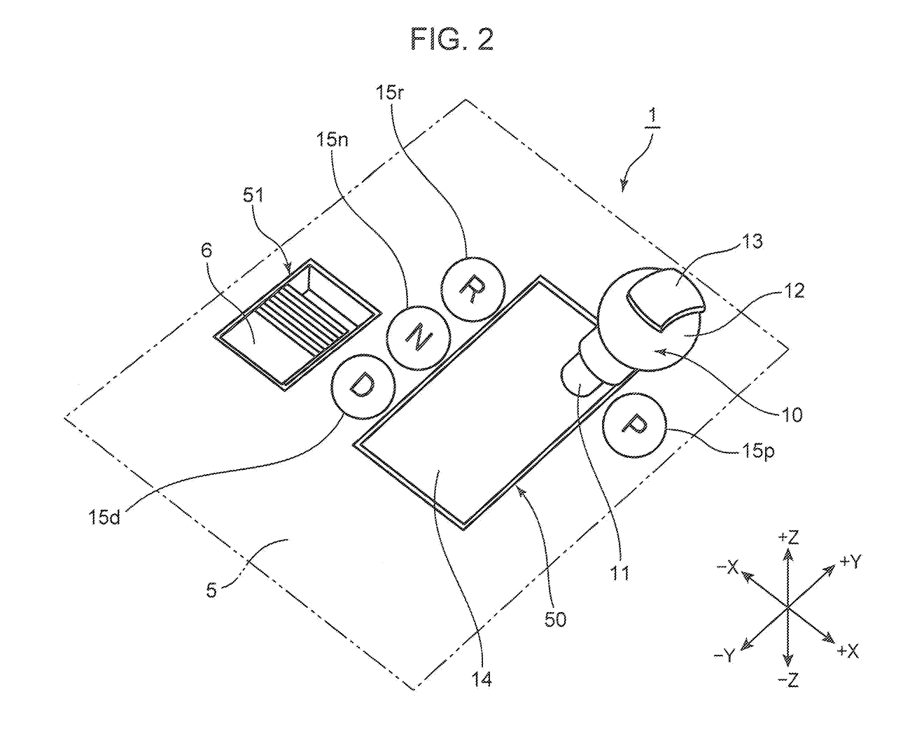

The external configuration of the vehicle shifting device 1 will be described with reference to FIG. 2. FIG. 2 is a schematic perspective view selectively illustrating a portion of the central console 5 in FIG. 1.

As illustrated in FIG. 2, the top face of the central console 5 is provided with an aperture 50 and a recess 51. The aperture 50 has a substantially rectangular shape in a plan view which is viewed from the +Z side. Likewise, the recess 51 also has a substantially rectangular shape in a plan view.

The parking switch 6 which is pivotable about the −Y end thereof is disposed in the recess 51 of the central console 5. There is a space in the +Y side of the recess 51. The driver can put a finger into the space.

A shift lever 10 is inserted in the aperture 50 of the central console 5 along Z direction. The shift lever 10 includes a lever body 11 having a form of a shaft, and a shift knob 12 attached to the +Z side of the lever body 11. A push button 13 which is to be pushed down by a driver is provided on the shift knob 12.

The aperture 50 of the central console 5 is covered to conceal the −Z side by a cover 14 except the portion where the lever body 11 is inserted.

Indicators 15p, 15r, 15n, and 15d that indicate shift positions are provided adjacent to the aperture 50 in the +X side and the −X side. One among the indicators 15p, 15r, 15n, and 15d that corresponds to the selected shift position is lit from the −Z side to let a driver to visually recognize the shift position easily.

3. Movement of Shift Lever 10

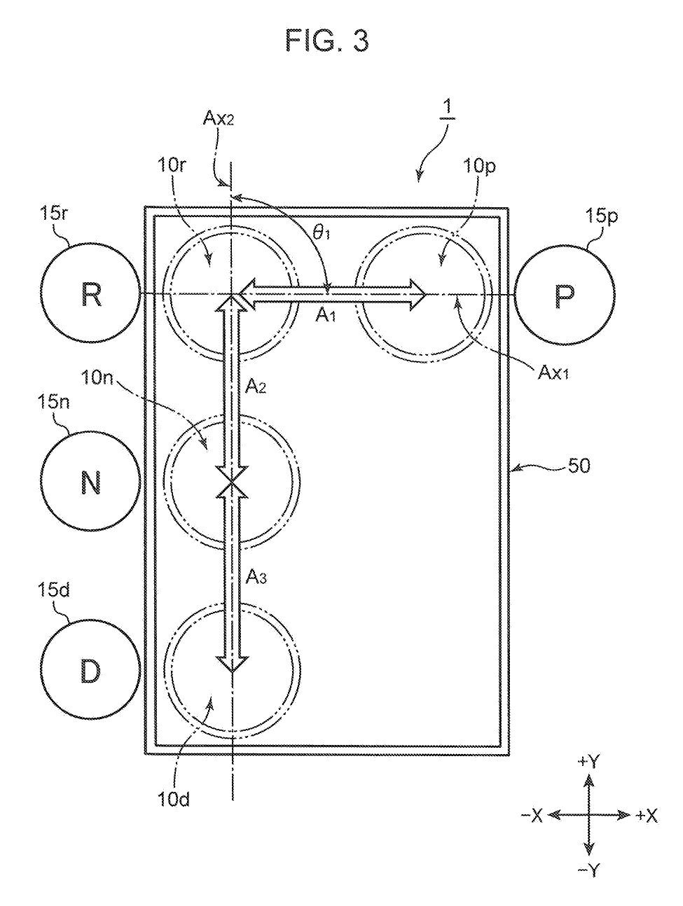

Movement of the shift lever 10 of the vehicle shifting device 1 according to the embodiment will be described with reference to FIG. 3. FIG. 3 is the schematic plan view illustrating the movement of the shift lever 10 of the vehicle shifting device 1.

In the vehicle shifting device 1 as illustrated in FIG. 3, the parking (P) position 10p and the reverse (R) position 10r are aligned along X direction. In other words, the P-position 10p and the R-position 10r are disposed along a line Ax₁ extending along X direction.

Meanwhile, in the vehicle shifting device 1, the R-position 10r, the neutral (N) position 10n, and the drive (D) position 10d are aligned along Y direction. That is, the R-position 10r, the N-position 10n, and the D-position 10d are disposed along a line Ax₂ extending along Y direction.

The line Ax₁ and the line Ax₂ intersect at angle θ₁. The angle θ₁ is, for example, 90°. Considering natural movements of an arm of the driver, the angle θ₁ may be smaller or larger than 90°.

When the driver wants to start the vehicle which is in a parking state, the driver first moves the shift lever 10 from the P-position 10p to the R-position 10r as indicated by arrow A₁. Then, when the driver wants to drive the vehicle in the forward direction, the driver moves the shift lever 10 from the R-position 10r to the N-position 10n and then to the D-position 10d, as indicated by arrow A₂ and arrow A₃, and then turns off the parking switch 6 (see FIGS. 1 and 2).

Along with the movement of the shift lever 10, one of the indicators 15p, 15r, 15n, and 15d corresponding to the position of the shift lever 10 is lit. The indicators 15p, 15r, 15n, and 15d are provided near the shift lever 10. Indicators that indicates the shift position is also provided in the metering unit 3 (see FIG. 1), although the details on the indicator is omitted in the drawings. This indicators is also lit corresponding to the movement of the shift lever 10.

4. Configuration of Shift Lever 10

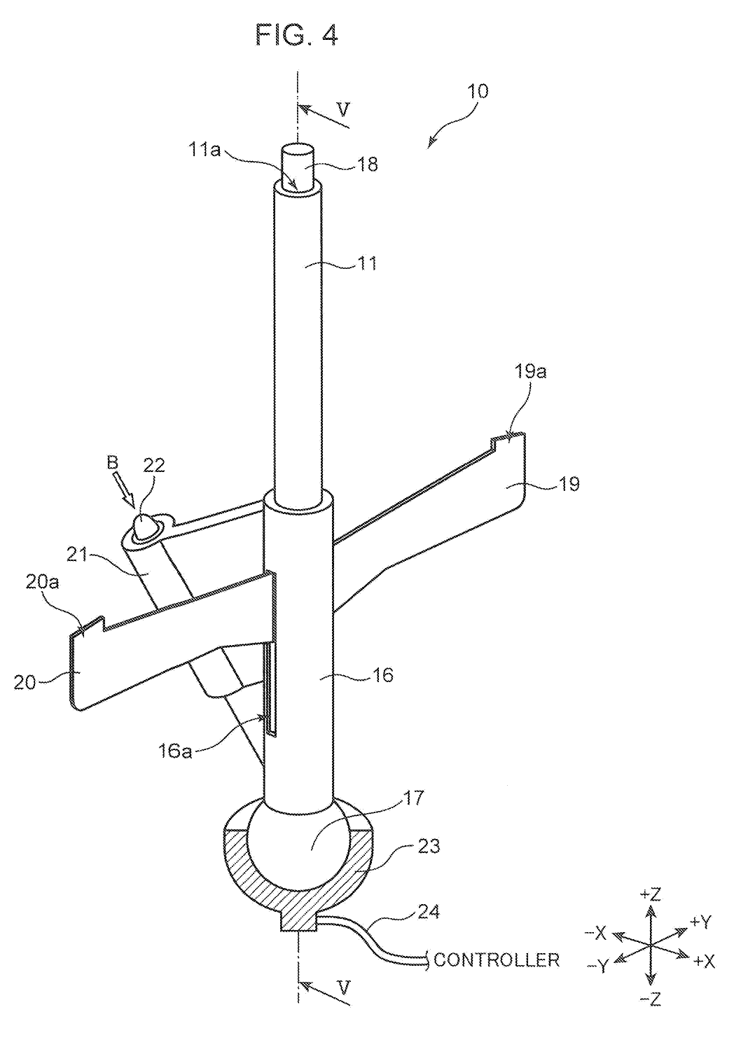

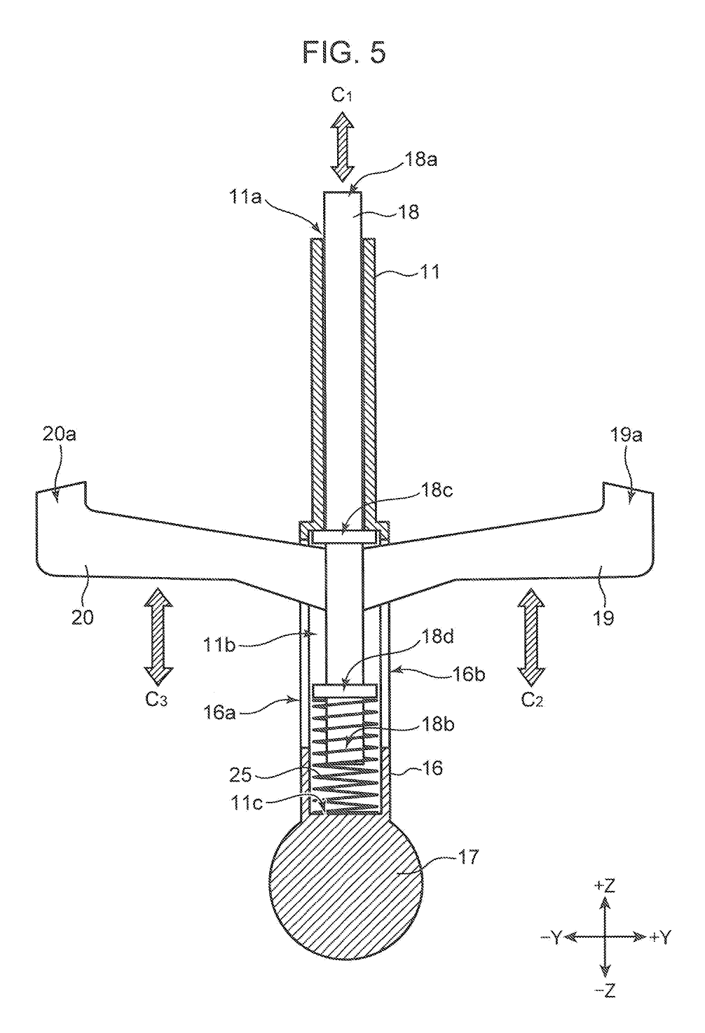

The configuration of the shift lever 10 will be described with reference to FIGS. 4 and 5. FIG. 4 is a schematic perspective view illustrating the configuration of the shift lever 10. FIG. 5 is a schematic sectional view taken along the line V-V in FIG. 4. In FIGS. 4 and 5, the shift knob 12 and the push button 13 are omitted.

As illustrated in FIG. 4, the shift lever 10 includes the lever body 11, a rod 18, guide levers 19 and 20, and a detent mechanism.

The lever body 11 is a cylindrical body extending in Z direction and having a large diameter at a lever lower portion 16 in the −Z side. A root part 17 is provided on the bottom end of the lever body 11. The root part 17 has a spherical shape without an upper part. The root part 17 is supported by a rotational angle sensor (detector) 23 that has a shape of a spherical shell covering the outer circumferential face of the root part 17. The lever body 11 is pivotable about the root part 17 as a pivot point so as the tip portion in the +Z side (where the shift knob 12 is provided) to pivot.

The rotational angle sensor (detector) 23 detects the rotational angle of the root part 17 and transmits an electric signal related to the rotational angle to the controller (e.g., an ECU) via a signal cable 24.

The lever body 11 is integrally formed with the lever lower portion 16 and the root part 17.

As illustrated in FIG. 5, the rod 18 is inserted in a sleeve hollow 11b in the lever body 11 in a manner allowed to move upward and downward along Z direction as indicated by arrow C₁. A spring (coil spring) 25, which is an elastic material, is provided in the −Z side of the rod 18 and urges the rod 18 toward the +Z side with an elastic force.

Flanges 18c and 18d are provided on the middle portion, regarding the longitudinal direction (Z direction), of the rod 18 to restrict the top end 18a from projecting more than a certain distance from the top opening 11a of the lever body 11. There is a gap between the bottom end 18b of the rod 18 and the bottom face 11c of the lever body 11. The gap is larger than the stroke by which the rod 18 moves along Z direction relative to the lever body 11.

An end of each of the guide levers 19 and 20 is joined to the rod 18. The guide levers 19 and 20 are joined to the rod 18 by joined sections on the middle portion, regarding the longitudinal direction (Z direction), of the rod 18. The joined sections are located in the −Z side of the flange 18c.

The guide lever 19 extends like an arm in the +Y side from the joined section of the rod 18, and the guide lever 20 extends like an arm in the −Y side from the joined section of the rod 18. Hook portions 19a and 20a protrude in the +Z side from the tip portions of the guide levers 19 and 20.

In conjunction with the rod 18 moving along Z direction as indicated by the arrow C₁, the guide levers 19 and 20 move upward and downward along Z direction as indicated by arrows C₂ and C₃. The rod 18 moves toward the −Z side by the driver pushing down the push button 13 (not shown) and toward the −Z side by an elastic force of a spring 25 if the driver cancels pushing down the push button 13. The guide levers 19 and 20 move upward and downward in conjunction with this action.

The lever lower portion 16 has openings 16a and 16b which allow the guide levers 19 and 20 to pass therein.

Referring back to FIG. 4, the detent mechanism includes a detent case 21 connected to the lever lower portion 16, and a detent plunger 22 housed in the detent case 21 and urged by an elastic force toward the +Z side. The detent plunger 22 retracts into the detent case 21 when a force acts on the detent plunger 22 as indicated by arrow B. The detent plunger 22 projects as illustrated in FIG. 4 when no such force acts.

5. Motion of Detent Mechanism Made by Manipulating Shift Lever 10

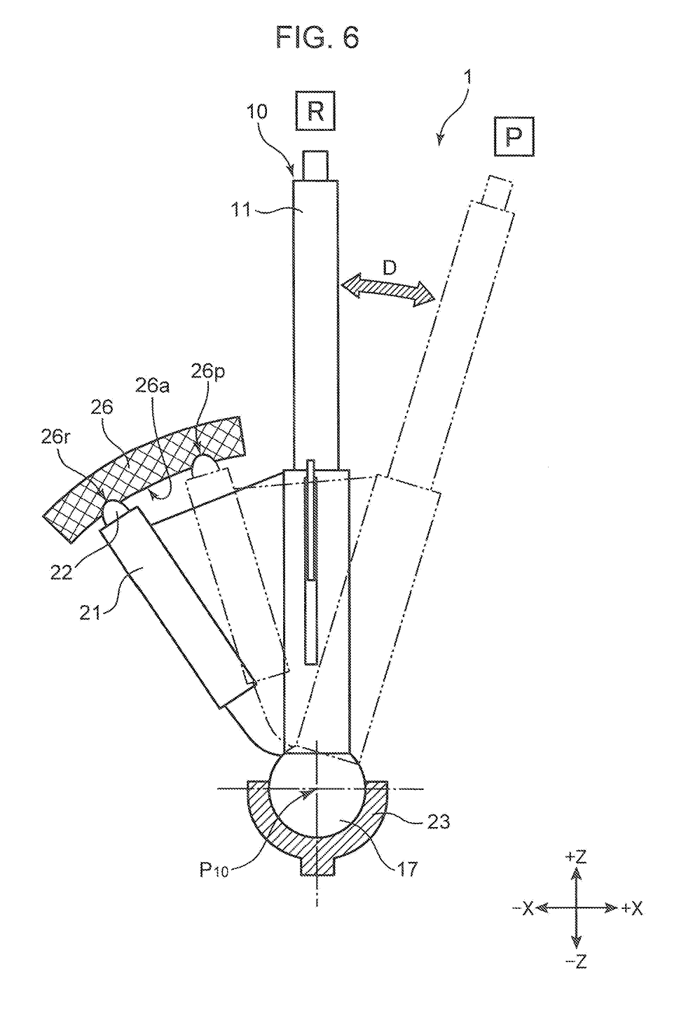

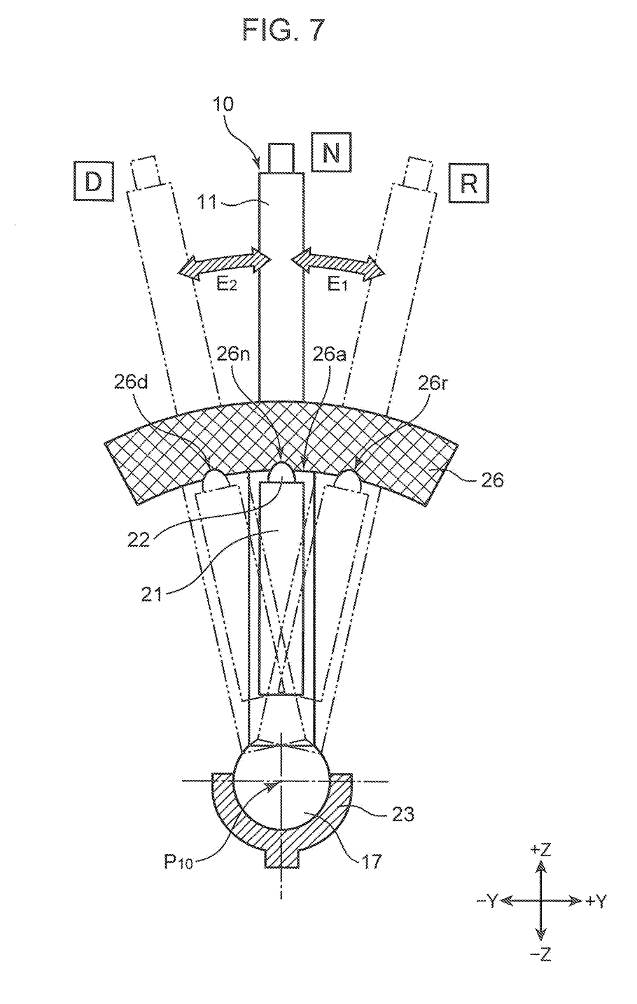

The motion of the detent mechanism made by the driver manipulating the shift lever 10 will be described with reference to FIGS. 6 and 7. FIG. 6 is a schematic sectional view illustrating the motion of the detent mechanism made by the driver moving the shift lever 10 among the P-position 10p and the R-position 10r. FIG. 7 is a schematic sectional view illustrating the motion of the detent mechanism made by the driver moving the shift lever 10 among the R-position 10r and the D-position 10d.

As illustrated in FIGS. 6 and 7, the detent guide 26 is disposed to cover the +Z side of the region in which the detent plunger 22 of the detent mechanism moves. The detent guide 26 is fixed to the bottom face, which faces the −Z side, of the central console 5. Recesses 26p, 26r, 26n, and 26d each of which is a space extending in the +Z side are provided in the bottom face 26a, which faces the −Z side, of the detent guide 26.

As illustrated in FIG. 6, the recess 26p and the recess 26r in the detent guide 26 are aligned along X direction (vehicle width direction). When the shift lever 10 is set to the P-position 10p as indicated by arrow D, the detent plunger 22 fits in the recess 26p.

In the same manner, when the shift lever 10 is set to the R-position 10r, the detent plunger 22 fits in the recess 26r as indicated by the arrow D.

When the tip portion of the detent plunger 22 is in contact with the bottom face 26a of the detent guide 26 during shifting, the spring (not shown) housed in the detent case 21 is compressed and the tip portion of the detent plunger 22 is pushed against the bottom face 26a without any gap therebetween.

As illustrated in FIG. 7, the recess 26r, the recess 26n, and the recess 26d in the detent guide 26 are aligned along Y direction (front-and-rear direction of the vehicle). When the shift lever 10 is set to the N-position 10n, the detent plunger 22 fits in the recess 26n as indicated by arrows E₁ and E₂.

In the same manner, when the shift lever 10 is set to the D-position 10d, the detent plunger 22 fits in the recess 26d as indicated by arrow E₂.

When the tip portion of the detent plunger 22 is positioned between the recesses 26r and 26n or between the recesses 26n and 26d during shifting, the spring (not shown) housed in the detent case 21 is compressed and the tip portion of the detent plunger 22 is pushed against the bottom face 26a without any gap therebetween.

The downward face 26a of the detent guide 26 has a shape of an arc face with its center on a pivot point P₁₀ about which the shift lever 10 pivots. Thus, the shift lever 10 can be manipulated smoothly.

6. Motion of Guide Levers 19 and 20 Made by Manipulating Shift Lever 10

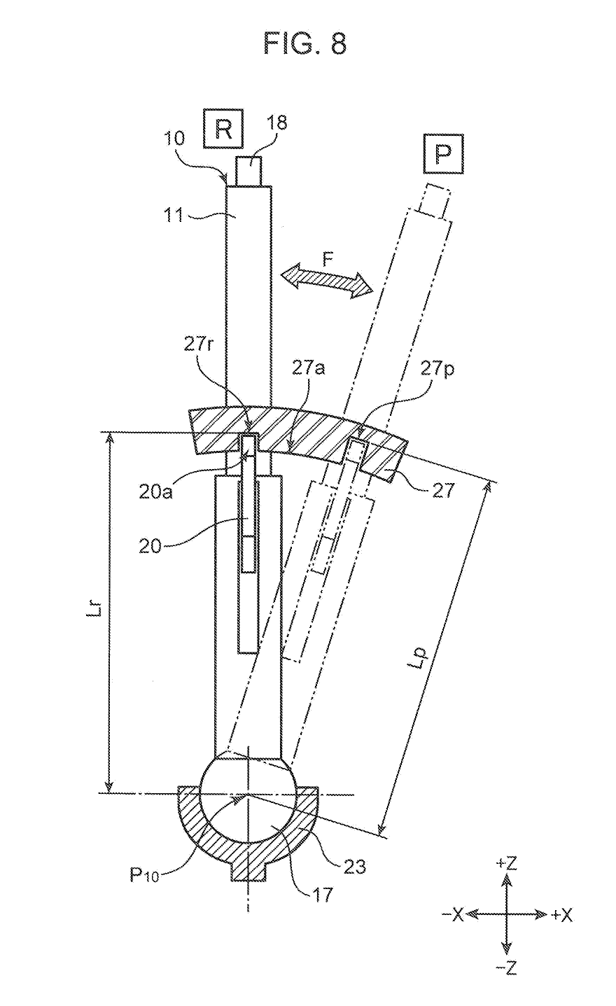

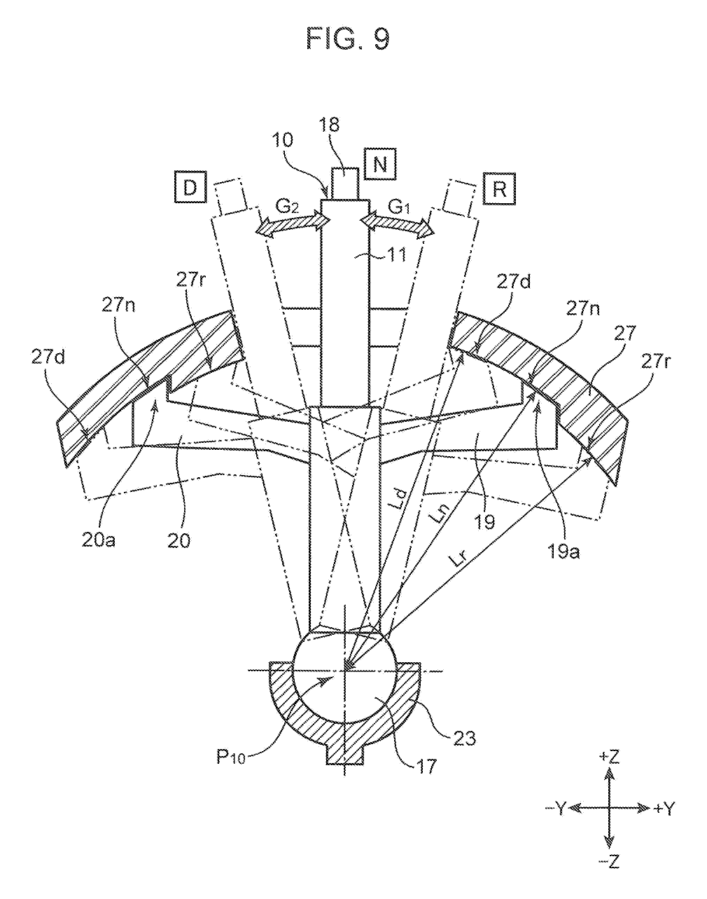

The motion of the guide levers 19 and 20 made by the driver manipulating the shift lever 10 will be described with reference to FIGS. 8 and 9. FIG. 8 is a schematic sectional view illustrating the motion of the guide lever 20 made by the driver moving the shift lever 10 among the P-position 10p and the R-position 10r. FIG. 9 is a schematic sectional view illustrating the motion of the guide levers 19 and 20 made by the driver moving the shift lever 10 among the R-position 10r and the D-position 10d. Although only the guide lever 20 is illustrated in FIG. 8 for convenience of illustration, the guide lever 19 moves in the same manner.

As illustrated in FIGS. 8 and 9, guides (lever holders) 27 are disposed so as to cover the +Z side of the region in which the hook portions 19a and 20a of the guide levers 19 and 20 move. The guides 27 (lever holders) are provided in the −Z side, namely the lower side, of the central console 5 and disposed along Y direction on both sides of the aperture 50, the guides 27 corresponding to the guide levers 19 and 20.

The guides (lever holders) 27 are also fixed to the inner face, which faces the −Z side, of the central console 5. The guide (lever holder) 27 provided further in the +Y side (front side of the vehicle) than the aperture 50 has the same shape as the guide (lever holder) 27 provided further in the −Y side (rear side of the vehicle) than the aperture 50.

Recesses 27p, 27r, 27n, and 27d each of which is a space extending in the +Z side are provided in the downward face 27a, which faces the −Z side, of the guide (lever holder) 27.

As illustrated in FIG. 8, the recess 27p and the recess 27r in the guide 27 are aligned along X direction (vehicle width direction). When the shift lever 10 is set to the P-position 10p as indicated by arrow F, the hook portions 19a and 20a of the guide levers 19 and 20 fit in the recesses 27p.

In a similar manner, when the shift lever 10 is set to the R-position 10r as indicated by the arrow F, the hook portions 19a and 20a of the guide levers 19 and 20 fit in the recesses 27r.

When the driver wants to move the shift lever 10 among the P-position 10p and the R-position 10r, the driver pushes the push button 13 (see FIG. 2) to push down the guide levers 19 and 20 together with the rod 18 in the −Z side. If the push button 13 is not pushed by the driver, the guide levers 19 and 20 are urged toward the +Z side by the spring 25 as illustrated in FIG. 8.

As illustrated in FIG. 8, distance (radius) Lr between the pivot point P₁₀ about which the shift lever 10 pivots and the bottom, in the +Z side, of the recess 27r and distance (radius) Lp between the pivot point P₁₀ and the bottom, in the +Z side, of the recess 27p satisfy the following relationship.

Lr<Lp Formula 1

Formula 1 expresses the relationship that the depth by which the hook portions 19a and 20a fit in the recesses 27r is shallow compared to the depth by which the hook portions 19a and 20a fit in the recesses 27p.

Regarding the portion of the downward face 27a of the guide (lever holder) 27 between the recess 27p and the recess 27r, the radius from the pivot point P₁₀ to the downward face 27a is smaller than the radius Lp and the radius Lr.

As illustrated in FIG. 9, the recess 27r, the recess 27n, and the recess 27d in the guide (lever holder) 27 are aligned along Y direction (front-and-rear direction of the vehicle). When the shift lever 10 is set to the N-position 10n as indicated by arrows G₁ and G₂, the hook portions 19a and 20a of the guide levers 19 and 20 fit in the recesses 27n.

In a similar manner, when the shift lever 10 is set to the D-position 10d as indicated by the arrow G₂, the hook portions 19a and 20a of the guide levers 19 and 20 fit in the recesses 27d.

As illustrated in FIG. 9, distance (radius) Lr between the pivot point P₁₀ about which the shift lever 10 pivots and the bottom, in the +Z side, of the recess 27r, distance (radius) Ln between the pivot point P₁₀ to the bottom, in the +Z side, of the recess 27n, and distance (radius) Ld between the pivot point P₁₀ and the bottom, in the +Z side, of the recess 27d satisfy the following relationship.

Lr<Ln=Ld Formula 2

Formula 2 expresses the relationship that the depth by which the hook portions 19a and 20a fit in the recesses 27r is shallow compared to the depth by which the hook portions 19a and 20a fit in the recesses 27n and the recesses 27d. As indicated by the arrow G₂, the shift lever 10 can be moved among the N-position 10n and the D-position 10d without the need of the driver pushing down the push button 13 (see FIG. 2).

7. Effect

The vehicle shifting device 1 according to the embodiment is a shift-by-wire shifting device that can be made totally small in size and gives a high degree of freedom in designing the device.

The vehicle shifting device 1 includes a mechanism (guide levers 19 and 20 and the guide (lever holder) 27) to keep the posture of the shift lever 10 at each of the shift-ranges, namely the shift positions 10p, 10r, 10n, and 10d. Thus, the driver can easily recognize the shift position 10p, 10r, 10n, or 10d by the posture of the shift lever 10 (position of the shift lever 10).

As described with reference to FIG. 3, the vehicle shifting device 1 according to the embodiment is such that the top end (the shift knob 12) of the shift lever 10 moves along the line Ax₁ perpendicular to the line Ax₂ when changing the shift-ranges among the P-range and the R-range. This allows the vehicle shifting device 1 to be made smaller in size in Y direction (front-and-rear direction of the vehicle) than a device in which the positions from the P-position 10p to the D-position 10d are linearly disposed along the line Axe.

As described with reference to FIG. 4, the vehicle shifting device 1 according to the embodiment employs such a configuration that the shift lever 10 is pivotable about the root part 17 of the shift lever as the pivot point P₁₀ and the rotational angle of the root part 17 is detected by the rotational angle sensor (detector) 23. This allows the vehicle shifting device 1 to be made small in size in Z direction (height direction of the vehicle).

As described with reference to FIGS. 8 and 9, the vehicle shifting device 1 according to the embodiment is such that the posture of the shift lever 10 is kept by the recesses 27p, 27r, 27n, and 27d in the guide (lever holder) 27 engaging with the hook portions 19a and 20a of the guide levers 19 and 20, which is a simple and secure configuration. This configuration reduces manufacturing cost, and the chances of malfunction of the mechanism are kept small.

As described with reference to FIGS. 8 and 9, the vehicle shifting device 1 according to the embodiment is such that the depth by which the hook portions 19a and 20a fit in the recesses 27r to reach the bottoms when the shift lever is set to the R-position 10r is shallow compared to the depth for other shift positions 10p, 10n, and 10d. This allows the driver to recognize and confirm the range by feeling of manipulating the shift lever 10 when shifting from the R-range to the P-range to park a vehicle, for example.

As described with reference to FIG. 5, the vehicle shifting device 1 according to the embodiment is such that the guide levers 19 and 20 are urged toward the +Z side by an elastic force of the spring 25 housed in the lower side of the lever lower portion 16. This keeps the guide levers 19 and 20 engaged with the recesses 27p, 27r, 27n, and 27d in the guide (lever holder) 27 unless the driver pushes down the push button 13. Thus, the selected shift-range is kept even if the driver or other passenger unintentionally hits the shift lever 10. As described above, higher degree of safety is secured by the vehicle shifting device 1 according to the embodiment.

As described with reference to FIGS. 4 and 5, the vehicle shifting device 1 according to the embodiment is such that the shift lever 10 is provided with two guide levers 19 and 20. This further reduces the chances of causing uneven stress in the shift lever 10 when set to any of the shift positions 10p, 10r, 10n, and 10d than a shift lever having a single guide lever. Furthermore, with the two guide levers 19 and 20 provided, the rigidity of the whole guide lever is increased.

As described with reference to FIGS. 6 and 7, the vehicle shifting device 1 according to the embodiment includes the detent mechanism (mechanism including the detent case 21 and the detent plunger 22) and the detent guide 26. This allows the driver to recognize the selected shift-range also from information obtained through a hand holding the shift knob 12 of the shift lever 10.

### (Exemplary Modification)

In the embodiment described above, the top end (the shift knob 12) of the shift lever 10 moves along the line Ax₂ when changing the shift position among the R-position 10r and the D-position 10d. The present invention is not limited to such a configuration. The top end of the shift lever 10 not necessarily moves along a straight line but may move along a curved line. In such a case, the top end may move along an arc that is curved about an elbow or a wrist of the driver.

In the embodiment described above, the line Ax₁ extends along X direction (vehicle width direction) and the line Ax₂ extends along the front-and-rear direction of the vehicle. The present invention is not limited to such a configuration. For example, the line Ax₁ and the line Ax₂ may respectively extend along Y direction (the front-and-rear direction of the vehicle) and the vehicle width direction.

In the embodiment described above, both the detent guide 26 and the guide (lever holder) 27 provided in the region lower than the central console 5 is disposed in the upper face of the region. The present invention is not limited to such a configuration. For example, a detent mechanism that protrudes or retracts a detent plunger along a radial direction of the shift lever 10 may be provided and a detent guide provided in the lower region of the central console may be disposed in the side face of the region.

In the embodiment described above, the shift lever 10 is provided with two guide levers 19 and 20. The present invention is not limited to such a configuration. Only one guide lever or three or more guide levers may be provided.

In the embodiment described above, the vehicle shifting device 1 is a shift-by-wire shifting device that changes the shift-range among the P-range, the R-range, the N-range, and the D-range. The present invention is not limited to such a configuration. For example, manual (M) range may be included in addition to the ranges described above.

In the embodiment described above, the driver seat is disposed in the left side in the vehicle room as an example. The present invention is not limited to such a configuration. For example, the driver seat may be disposed in the right side in the vehicle room.

In the embodiment described above, the indicators 15p, 15r, 15n, and 15d are provided around the aperture 50 in the central console 5. The present invention is not limited to such a configuration. For example, an indicator may be provided on the upper portion of the shift knob 12 to display the shift-range.

In the embodiment described above, the vehicle shifting device 1 is provided in the central console 5. The vehicle shifting device is not necessarily provided in such a place. For example, the vehicle shifting device may be provided in the instrumental panel.

In the embodiment described above, shifting to the P-range is also made by manipulating the shift lever 10. The present invention is not limited to such a configuration. For example, a switch for shifting to the P-range may be provided in addition to the vehicle shifting device.

### (Summary)

A vehicle shifting device according to one aspect of the present invention is a shift-by-wire vehicle shifting device for changing a shift-range of a vehicle among a plurality of shift-ranges including a parking range, a reverse range, a neutral range, and a drive range based on manipulation made by a driver. The vehicle shifting device includes a shift lever that is set to a position corresponding to a shift lever that is set to positions corresponding to the plurality of shift-ranges, a detector that detects the position of the shift lever, and a lever holder that keeps the shift lever in one of the positions while the shift-range is kept in a predetermined shift-range, the one of the positions corresponding to the predetermined shift-range.

The vehicle shifting device according to the aspect is a shift-by-wire shifting device that can be made totally small in size and gives a high degree of freedom in designing.

The vehicle shifting device according to the aspect includes a lever holder that keeps the shift lever in a position corresponding to the shift-range as described above. Thus, the position of the shift lever is kept even if the driver is not holding the shift lever, and the driver can directly recognize the current range by the position of the shift lever.

Thus, the vehicle shifting device according to the aspect enables the device to be made totally small in size and gives a high degree of freedom in designing while allowing the driver to recognize a shift position by the position of a shift lever.

In the vehicle shifting device having the aforementioned configuration, in a plan view of the shift lever viewed from above, the shift lever moves along a first straight line when the shift-range is changed among the reverse range, the neutral range, and the drive range, and the shift lever moves along a second straight line that intersects the first straight line when the shift-range is changed among the parking range and the reverse range.

The vehicle shifting device is such that the shift lever moves along the second straight line perpendicular to the first straight line when changing the shift-ranges among the parking range and the reverse range. This enables the device to be made small in size in the direction along the first straight line compared to a device configured to move the shift lever along the first straight line also when changing the shift-ranges among the parking range and the reverse range.

In the vehicle shifting device having the aforementioned configuration, the shift lever is pivotable about a pivot point which is a root part at a bottom end of the shift lever so as a top end of the shift lever to move along the first straight line and the second straight line, and the detector is a rotational angle sensor that detects a rotational angle of the root part of the shift lever.

The vehicle shifting device employs such a configuration that the shift lever is pivotable about the root part as the pivot point and the position of the shift lever is detected by the rotational angle of the root part. This allows the device to be made smaller in size in the height direction of the vehicle (longitudinal direction of the shift lever). That is, the vehicle can be made small in size in the vehicle height direction compared to such a device that has a shift lever extending downward beyond the pivot point of the shift lever to detect the rotational angle by an end of the extended portion.

In the vehicle shifting device having the aforementioned configuration, the shift lever has a push button provided on the top end and a guide lever provided lower than the top end, the guide lever being configured to move by the driver manipulating the push button, the lever holder is provided near the shift lever to serve as a guide including recesses or holes that engage with the guide lever when the shift lever is set to the positions corresponding to the shift-ranges, which are the parking range, the reverse range, the neutral range, and the drive range, and the guide lever engages with the recess or the hole in the guide to keep the position of the shift lever.

The vehicle shifting device is such that the position of the shift lever for each shift-range is kept by the recess or the hole in the guide engaging with the guide lever, which is a simple and secure mechanism. This mechanism reduces manufacturing cost, and the chances of malfunction of the mechanism are kept small.

In the vehicle shifting device having the aforementioned configuration, the guide lever extends outward in a radial direction of the shift lever from a longitudinally middle portion of the shift lever and has a hook portion protruding upward from a tip portion of the guide lever, and the hook portion fits in the recess or the hole in the guide and thereby the guide lever engages with the guide.

The vehicle shifting device is such that the hook portion of the tip portion of the guide lever fits in the recess or the hole to engage the guide lever with the guide. This allows the driver to easily recognize by feeling that a predetermined shift position is set.

In the vehicle shifting device having the aforementioned configuration, a depth by which the hook portion fits in the recess or the hole in the guide when the shift-range is set to the reverse range is shallow compared to the depth for other shift-ranges.

This vehicle shifting device is such that the depth by which the hook portion fits in when the shift-range is set to the reverse range is shallow compared to depths for other shift-ranges. This allows the driver to recognize the range by feeling of manipulating the shift lever when shifting from the reverse range to the parking range to park a vehicle, for example.

In the vehicle shifting device having the aforementioned configuration, the guide lever is urged upward by an elastic force.

The vehicle shifting device is such that the guide lever is urged upward by an elastic force. This keeps the guide lever engaged with the guide unless the driver manipulates the shift lever. Thus, the selected shift-range is kept even if the driver or other passenger unintentionally hits the shift lever. Thus, higher degree of safety is secured by the vehicle shifting device according to the aspect.

In the vehicle shifting device having the aforementioned configuration, a plurality of the guide levers is provided to the shift lever, and the guides are provided to positions corresponding to the plurality of the guide levers.

The vehicle shifting device is such that the shift lever is provided with a plurality of guide levers. This further reduces chances of causing uneven stress in the shift lever when set to each shift position than for a case of a shift lever provided with a single guide lever. Furthermore, with a plurality of guide levers provided, the rigidity of the whole lever holder is increased.

In the vehicle shifting device having the aforementioned configuration, the shift-lever includes a detent mechanism that allows a detent plunger to protrude or retract and is provided lower than the top end, and a detent guide is provided near the shift lever and has recesses and holes in which the detent plunger intrudes when the shift lever is set to the position corresponding to any of the shift-ranges, which are the parking range, the reverse range, the neutral range, and the drive range.

The vehicle shifting device includes the detent mechanism and the detent guide. This allows the driver to recognize the selected shift-range also by the information obtained from the hand holding the shift lever (such as information given by a repulsive force).

The vehicle shifting device is such that the detent plunger intrudes in the recess or the hole in the detent guide and thereby the position of the shift lever is surely kept at each shift-range.

As described above, this vehicle shifting device according to the aspects described above enables the device to be made totally small in size and gives a high degree of freedom in designing while allowing the driver to recognize the driving range by the position of a shift lever.

This application is based on Japanese Patent application No. 2017-171166 filed in Japan Patent Office on Sep. 6, 2017, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A shift-by-wire vehicle shifting device for changing a shift-range of a vehicle among a plurality of shift-ranges including a parking range, a reverse range, a neutral range, and a drive range based on manipulation made by a driver, the vehicle shifting device comprising:
a shift lever that is set to positions corresponding to the plurality of shift-ranges;
a detector that detects the position of the shift lever; and
a lever holder that keeps the shift lever in one of the positions while the shift-range is kept in a predetermined shift-range, the one of the positions corresponding to the predetermined shift-range.

2. The vehicle shifting device according to claim 1, wherein,
in a plan view of the shift lever viewed from above,
the shift lever moves along a first straight line when the shift-range is changed among the reverse range, the neutral range, and the drive range, and
the shift lever moves along a second straight line that intersects the first straight line when the shift-range is changed among the parking range and the reverse range.

3. The vehicle shifting device according to claim 2, wherein
the shift lever is pivotable about a pivot point which is a root part at a bottom end of the shift lever so as a top end of the shift lever to move along the first straight line and the second straight line, and
the detector is a rotational angle sensor that detects a rotational angle of the root part of the shift lever.

4. The vehicle shifting device according to claim 2, wherein
the shift lever has a push button provided on the top end of the shift lever and a guide lever provided lower than the top end, the guide lever being configured to move by the driver manipulating the push button,
the lever holder is provided near the shift lever to serve as a guide including recesses or holes that engage with the guide lever when the shift lever is set to any of the positions corresponding to the shift-ranges, which are the parking range, the reverse range, the neutral range, and the drive range, and
the guide lever engages with the recess or the hole in the guide to keep the position of the shift lever.

5. The vehicle shifting device according to claim 4, wherein
the guide lever extends outward in a radial direction of the shift lever from a longitudinally middle portion of the shift lever and has a hook portion protruding upward from a tip portion of the guide lever, and
the hook portion fits in the recess or the hole in the guide and thus the guide lever engages with the guide.

6. The vehicle shifting device according to claim 5, wherein
a depth by which the hook portion fits in the recess or the hole in the guide when the shift-range is set to the reverse range is shallow compared to the depth for other shift-ranges.

7. The vehicle shifting device according to claim 5, wherein
the guide lever is urged upward by an elastic force.

8. The vehicle shifting device according to claim 6, wherein
the guide lever is urged upward by an elastic force.

9. The vehicle shifting device according to claim 4, wherein
a plurality of the guide levers is provided to the shift lever, and
a plurality of the guides is provided to positions corresponding to the plurality of the guide levers.

10. The vehicle shifting device according to claim 2, wherein
the shift-lever includes a detent mechanism that allows a detent plunger to protrude or retract and is provided lower than the top end, and
a detent guide is provided near the shift lever and has recesses and holes in which the detent plunger intrudes when the shift lever is set to any of the positions corresponding to the shift-ranges, which are the parking range, the reverse range, the neutral range, and the drive range.

11. A shift-by-wire vehicle shifting device for changing a shift-range of a vehicle among a plurality of shift-ranges including a parking range, a reverse range, a neutral range, and a drive range based on manipulation made by a driver, the vehicle shifting device comprising:
a shift lever that is set to positions corresponding to the plurality of shift-ranges;
a detector that detects the position of the shift lever; and
a lever holder that keeps the shift lever in one of the positions while the shift-range is kept in a predetermined shift-range, the one of the positions corresponding to the predetermined shift-range,
wherein in a plan view of the shift lever viewed from above,
the shift lever moves along a first straight line when the shift-range is changed among the reverse range, the neutral range, and the drive range,
the shift lever moves along a second straight line that intersects the first straight line when the shift-range is changed among the parking range and the reverse range,
the shift lever has a push button provided on a top end of the shift lever and a guide lever provided lower than the top end, the guide lever being configured to move by the driver manipulating the push button,
the lever holder is provided near the shift lever to serve as a guide including recesses or holes that engage with the guide lever when the shift lever is set to any of the positions corresponding to the shift-ranges, which are the parking range, the reverse range, the neutral range, and the drive range,
the guide lever engages with the recess or the hole in the guide to keep the position of the shift lever, and
a depth by which the hook portion fits in the recess or the hole in the guide when the shift-range is set to the reverse range is shallow compared to the depth for other shift-ranges.
